(19) United States
(12) Patent Application Publication
(10) Pub. No.: US 2025/0340449 A1
(43) Pub. Date: Nov. 6, 2025

(54) THE PRODUCTION METHOD OF LITHIUM CARBONATE USED IN THE CATHODE MATERIAL OF LITHIUM-ION BATTERIES FROM BUXITE ORE

(71) Applicant: ETI ALÜMINYUM ANONIM SIRKET, Konya (TR)

(72) Inventor: Meral BAYGÜL, Konya (TR)

(21) Appl. No.: 18/867,457

(22) PCT Filed: Aug. 4, 2023
(86) PCT No.: PCT/TR2023/050779

§ 371 Date: Nov. 20, 2024

(30) Foreign Application Priority Data
Sep. 6, 2022 (TR) 2022/013883

(51) Int. Cl. C01D 15/08

(52) U.S. Cl. CPC C01D 15/08; C01P 2002/72; C01P 2006/40; C01P 2006/80

(57) ABSTRACT

The invention relates to the production method of lithium carbonate (Li₂CO₃) from bauxite ore, which provides lithium recovery for use in the cathode material of rechargeable li-ion batteries that enable the operation of portable computers, tablet computers, smartphones, electric vehicles by removing lithium with negative effects from the process in facilities where aluminum hydroxide (Al(OH)₃) production process is performed using bauxite ore.

### TECHNICAL FIELD

The invention relates to the production method of lithium carbonate (Li₂CO₃) from bauxite ore, which is carried out by removing lithium, which has negative effects in the process, in facilities where aluminum hydroxide (Al(OH)₃) production process is carried out using bauxite ore, and which provides lithium recovery for use in the cathode material of rechargeable li-ion batteries that enable portable computers, tablet computers, smartphones, electric vehicles to operate, and which is carried out with the following process steps:
dissolution of lithium (300-350 ppm) in bauxite ore under high temperature and pressure of 250° C.-280° C. in a basic environment and passing it into sodium aluminate solution,
precipitation of lithium aluminum carbonate hydroxy hydrate (Li₂Al₄(CO₃)(OH)₁₂·3H₂O) by adding sodium aluminate solution with specified lithium (25-30 ppm) and aluminum hydroxide into the precipitation tank,
after filtering the precipitated lithium aluminum carbonate hydroxy hydrate (Li₂Al₄(CO₃)(OH)₁₂·3H₂O) structure using a press filter, taking the lithium-free solution into the lithium-free solution tank and the solid lithium cake into the lithium cake bunker,
sending the lithium cake containing 2-2.5% lithium in the lithium cake bunker to the cake preparation tank where it is mixed with water,
sending the resulting mixture to the reactor where lithium is taken into the liquid phase under high temperature and pressure,
pressing and filtering for liquid/solid separation after the reactor,
sending the solid in the brychite structure obtained in the filtration stage to the process to obtain aluminum hydroxide in the plant,
sending the liquid phase product, which is determined to contain 1000-1200 ppm lithium in the filtration stage, to the evaporator,
obtaining lithium carbonate with approximately 100% purity by evaporating the liquid solution containing lithium through an evaporator, filtering it again and drying it

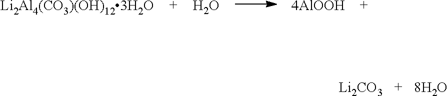

### PRIOR ART

Today, rechargeable li-ion batteries are used to power portable computers, tablets, smartphones and electric vehicles.

Lithium carbonate (Li₂CO₃) used in Li-ion batteries is commercially produced from minerals and lake water. In the production of lithium carbonate Li₂CO₃, lake water containing lithium is taken into ponds and evaporated with solar energy, calcium chloride CaCl₂) is added to the solution whose lithium concentration is increased and sulfate ion is precipitated as gypsum. Sodium chloride (NaCl), potassium chloride (KCl), magnesium chloride (MgCl₂) in the environment are separated by precipitating as sulfate.

Boron and magnesium from the solution with lithium content between 4-6% are precipitated by adding lime and soda ash, then lithium carbonate (Li₂CO₃) is crystallized from the solution.

Sulfuric acid (H₂SO₄) and sodium carbonate (Na₂CO₃) extraction methods are used to obtain lithium carbonate (Li₂CO₃) from minerals. First, α-spodumene is calcined and converted into β-spodumene. After acid roasting at 200° C., β-spodumene is taken into lithium sulfate (Li₂SO₄) water. Lithium carbonate (Li₂CO₃) is crystallized by adding sodium carbonate (Na₂CO₃) and increasing the temperature.

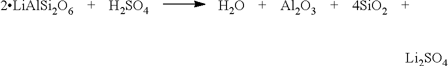

Sodium carbonate (Na₂CO₃) extraction is carried out in an autoclave at 215° C. and 20 bar pressure. CO₂ is introduced into the medium and insoluble lithium carbonate (Li₂CO₃) is converted into lithium bicarbonate (LiHCO₃). Heated lithium carbonate (Li₂CO₃) is crystallized.

The increase in the use of lithium batteries with the development of technology increases the need for lithium carbonate (Li₂CO₃) raw material. Limited lithium reserves change the supply and demand balance, thus increasing the need for new lithium resources. Obtaining lithium carbonate (Li₂CO₃) from minerals is more costly than obtaining it from lakes. The production of lithium carbonate (Li₂CO₃) from lithium minerals requires high temperature calcining. This causes the lithium carbonate (Li₂CO₃) production method to be a high energy cost process.

As a result, due to the negativities encountered in the known state of the technique and described above, it is necessary to make improvements in the relevant technical field.

### PURPOSE OF THE INVENTION

Due to the drawbacks inherent in the prior art, the invention aims to solve all the described drawbacks.

The aim of the invention is to provide the production method of lithium carbonate (Li₂CO₃) from bauxite ore, which is realized by removing lithium, which has negative effects in the process, in the facilities where aluminum hydroxide (Al(OH)₃) production process is carried out using bauxite ore, and which provides lithium recovery for use in the cathode material of rechargeable li-ion batteries that enable portable computers, tablet computers, smartphones, electric vehicles to operate, and which is carried out with the following process steps:
dissolution of lithium (300-350 ppm) in bauxite ore under high temperature and pressure of 250° C.-280° C. in a basic environment and passing it into sodium aluminate solution,
precipitation of lithium aluminum carbonate hydroxy hydrate (Li₂Al₄(CO₃)(OH)₁₂·3H₂O) by adding sodium aluminate solution with specified lithium (25-30 ppm) and aluminum hydroxide into the precipitation tank,
after filtering the precipitated lithium aluminum carbonate hydroxy hydrate (Li₂Al₄(CO₃)(OH)₁₂·3H₂O) structure using pressing and filtering, taking the lithium-free solution to the lithium-free solution tank and the powdered lithium cake to the lithium cake bunker,
sending the lithium cake containing 2-2.5% lithium in the lithium cake bunker to the cake preparation tank where it is mixed with water,
sending the resulting mixture to the reactor where lithium is taken into the liquid phase under high temperature and pressure,
pressing and filtering for liquid/solid separation after the reactor,
sending the solid in the brychite structure obtained in the filtration stage to the process to obtain aluminum hydroxide in the plant,
sending the liquid phase product, which is determined to contain 1000-1200 ppm lithium in the filtration stage, to the evaporator,
obtaining lithium carbonate with 99.6% purity by evaporating the liquid solution containing lithium through an evaporator, filtering it again and drying it.

To enable the lithium carbonate obtained by the inventive method to be used as raw material for the production of other lithium compounds in the glass, ceramic, glaze and enamel industry, except for li-ion batteries.

Thanks to the method subject to the invention;
production of lithium carbonate (Li₂CO₃) from bauxite ore is realized, thus ensuring the use of bauxite as a new raw material source in the production of lithium compounds,
the use of bauxite has led to an increase in lithium reserves,
low-cost lithium extraction compared to the state of the art is provided,
the negative effects of lithium on the process is eliminated by removing lithium from the process during lithium extraction from bauxite,
a high purity product that can be used in lithium batteries is obtained,
the structure, composed of equipment that is technically easy to install and operate, is provided without burdening the business.

### EXPLANATION OF THE FIGURES

FIG. 1; Schematic view of the equipment used in the production of lithium carbonate (Li₂CO₃) from bauxite ore.

FIG. 2; Analysis graph showing the mineralogical structure of the cake precipitated from Sodium Aluminate Solution with the addition of Aluminum Hydroxide in XRD (GNR-Explorer) diffractometer device.

FIG. 3; Analysis graph showing the mineralogical structure of lithium carbonate (Li₂CO₃) obtained from bauxite ore by lithium carbonate (Li₂CO₃) production method in XRD (GNR-Explorer) diffractometer device.

### REFERENCE NUMBERS

1. Precipitation tank
2. Filter
3. Lithium-free solution tank
4. Lithium cake bunker
5. Cake preparation tank
6. Reactor
7. Evaporator

### DETAILED DESCRIPTION OF THE INVENTION

Today, rechargeable li-ion batteries are used to power portable computers, tablets, smartphones and electric vehicles.

Lithium carbonate (Li₂CO₃) is needed as cathode material in the production of li-ion batteries.

Currently, lithium carbonate (Li₂CO₃) is produced by methods developed from minerals and lake waters. Since the methods developed for the production of lithium carbonate (Li₂CO₃) are costly, a method for the production of lithium carbonate (Li₂CO₃) from bauxite ore subject to the invention has been developed.

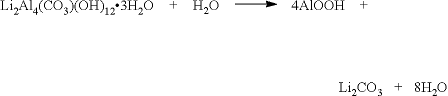

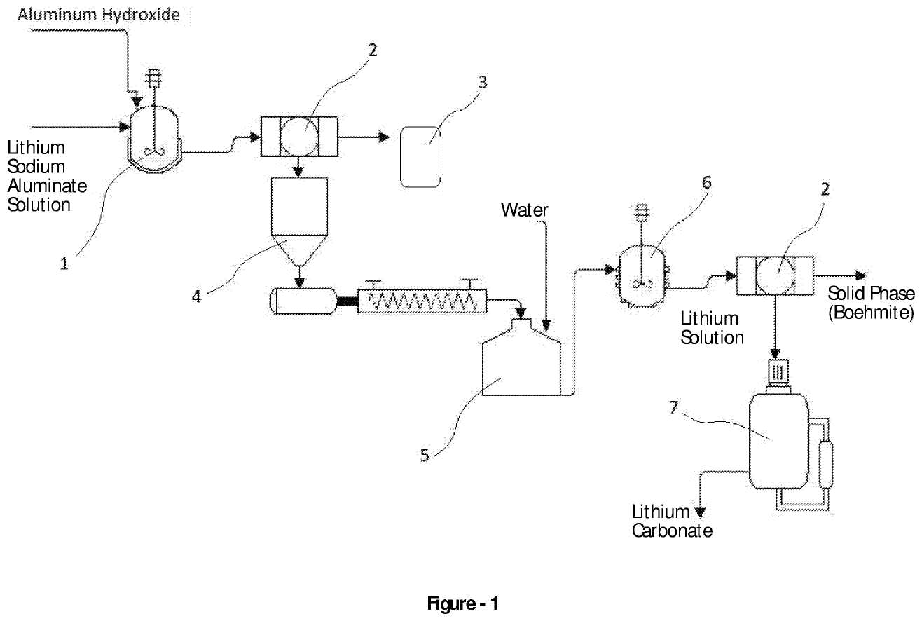

FIG. 1 shows a schematic view of the equipment used in the lithium carbonate (Li₂CO₃) production method from bauxite ore, which is integrated into the facilities where aluminum hydroxide (Al(OH)₃) is produced using bauxite ore.

In the application process of the method subject to the invention, which provides lithium recovery for use in the cathode material of rechargeable li-ion batteries that enable the operation of portable computers, tablet computers, smartphones, electric vehicles by removing lithium, which has negative effects in the process, in facilities where aluminum hydroxide (Al(OH)₃) production process is carried out using bauxite ore, firstly, the lithium (300-350 ppm) contained in bauxite ore is dissolved under high temperature and pressure of 250° C.-280° C. in basic environment and passed into sodium aluminate solution.

As shown in FIG. 1, sodium aluminate solution with the specified lithium (25-30 ppm) and aluminum hydroxide are added into the precipitation tank (1) and precipitated in the structure of lithium aluminum carbonate hydroxy hydrate (Li₂Al₄(CO₃)(OH)₁₂·3H₂O). After pressing the precipitated lithium aluminum carbonate hydroxy hydrate (Li₂Al₄(CO₃)(OH)₁₂·3H₂O) structure and filtering it through filter (2), the lithium-free solution is taken to the lithium-free solution tank (3) and the solid lithium cake is taken to the lithium cake bunker (4).

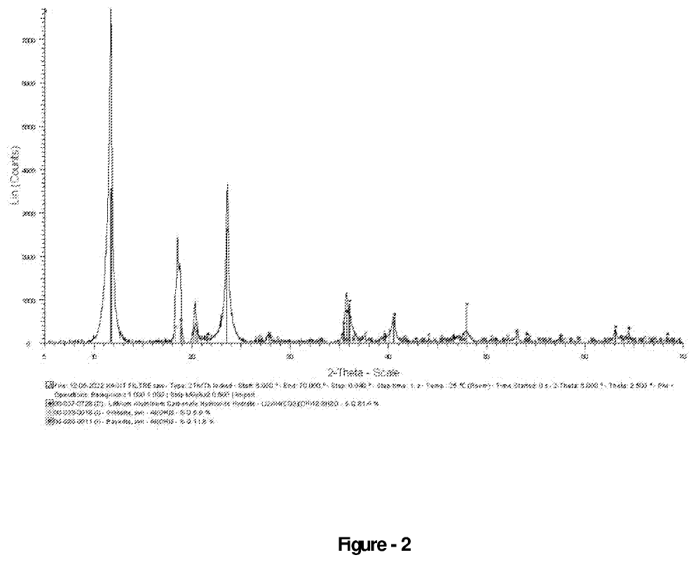

Lithium in Sodium Aluminate Solution precipitates with Aluminum Hydroxide forming the structure of lithium aluminum carbonate hydroxy hydrate (Li₂Al₄(CO₃)(OH)₁₂·3H₂O). (FIG. 2 (XRD (GNR-Explorer) diffractometer analysis graph showing the Mineralogical structure)

The lithium cake containing 2-2.5% lithium, located in the lithium cake bunker (4), is sent to the cake preparation tank (5) where it is mixed with water. The resulting mixture is sent to the reactor (6) where lithium is taken into the liquid phase under high temperature and pressure.

After the reaction in the reactor (6), pressing and filtering (2) are performed for liquid/solid separation. The solid in the bismite structure obtained in the filtration (2) stage is sent to the process to obtain aluminum hydroxide in the plant and the solution in the liquid phase, which is determined to contain 1000-1200 ppm lithium, is sent to the evaporator (7).

Lithium carbonate (Li₂CO₃) with approximately 100% purity is obtained by evaporating the liquid solution containing lithium through evaporator (7), filtering it again (2) and drying it.

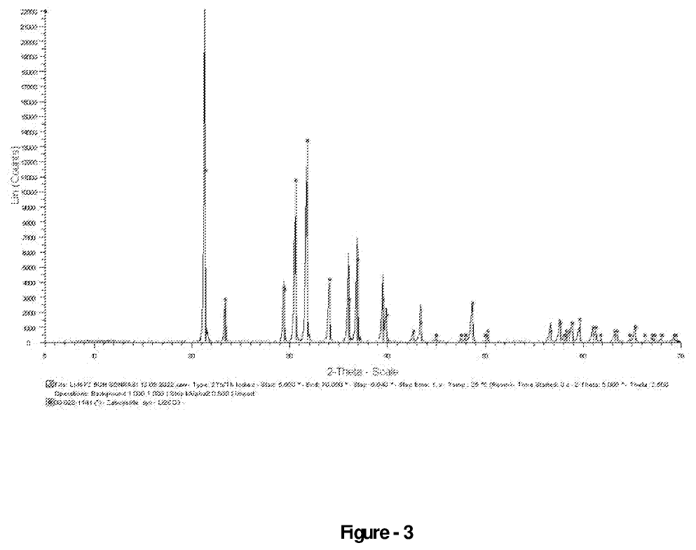

The obtained lithium carbonate (Li₂CO₃) has been seen,
as 100% lithium carbonate (Li₂CO₃) when analyzed by XRD (GNR-Explorer) diffractometer (FIG. 3),
in the purity of lithium carbonate (Li₂CO₃) raw material used in lithium-ion battery cathode material.

Lithium carbonate obtained by the method subject to the invention can be used as raw material for the production of other lithium compounds in the glass, ceramic, glaze and enamel industry, except for li-ion batteries.

Thanks to the method subject to the invention;
production of lithium carbonate (Li₂CO₃) from bauxite ore is realized, thus ensuring the use of bauxite as a new raw material source in the production of lithium compounds,
the use of bauxite has led to an increase in lithium reserves,
low-cost lithium extraction compared to the state of the art is provided,
the negative effects of lithium on the process is eliminated by removing lithium from the process during lithium extraction from bauxite,
a high purity product that can be used in lithium batteries is obtained,
the structure, composed of equipment that is technically easy to install and operate, is provided without burdening the business.

1. The invention is a method that provides lithium recovery for use in the cathode material of rechargeable li-ion batteries that enable the operation of portable computers, tablet computers, smartphones, electric vehicles by removing lithium, which has negative effects in the process, in facilities where aluminum hydroxide (Al(OH)₃) production process is performed using bauxite ore, and is characterized by the method of lithium carbonate (Li₂CO₃) production from bauxite ore, which is carried out with the following process steps;
dissolution of lithium (300-350 ppm) in bauxite ore under high temperature and pressure of 250° C.-280° C. in a basic environment and passing it into sodium aluminate solution,
precipitation of lithium aluminum carbonate hydroxy hydrate (Li₂Al₄(CO₃)(OH)₁₂·3H₂O) by adding sodium aluminate solution with specified lithium (25-30 ppm) and aluminum hydroxide into the precipitation tank,
after filtering the precipitated lithium aluminum carbonate hydroxy hydrate (Li₂Al₄(CO₃)(OH)₁₂·3H₂O) structure using pressing and filtering, taking the lithium-free solution to the lithium-free solution tank and the solid lithium cake to the lithium cake bunker,
sending the lithium cake containing 2-2.5% lithium in the lithium cake bunker to the cake preparation tank where it is mixed with water,
the resulting mixture is sent to the reactor, where lithium is taken into the liquid phase under high temperature and pressure,
pressing and filtering for liquid/solid separation after the reactor,
sending the solid in the brychite structure obtained in the filtration
stage to the process to obtain aluminum hydroxide in the plant,
sending the liquid phase product, which is determined to contain 1000-1200 ppm lithium in the filtration stage, to the evaporator,
obtaining lithium carbonate with approximately 100% purity by evaporating the liquid solution containing lithium through an evaporator, filtering it again and drying it
